(19) United States
(12) Patent Application Publication
(10) Pub. No.: US 2026/0115917 A1
(43) Pub. Date: Apr. 30, 2026

(54) ROBOTIC COLLABORATION FOR SAFE MATERIAL MOVEMENT IN A WORKFLOW

(71) Applicant: INTERNATIONAL BUSINESS MACHINES CORPORATION, Armonk, NY (US)

(72) Inventors: Sarbajit Kumar Rakshit, Kolkata (IN); Tushar Agrawal, West Fargo, ND (US); Vinod Anandram Valecha, Pune (IN); Randy A. Rendahl, Raleigh, NC (US)

(21) Appl. No.: 18/928,712

(22) Filed: Oct. 28, 2024

(51) Int. Cl. B25J 9/16; B25J 9/00

(52) U.S. Cl. CPC B25J 9/1674; B25J 9/0084; B25J 9/1653; B25J 9/1664

(57) ABSTRACT

An embodiment for robotic collaboration for safe material movement in a workflow is provided. The embodiment may include receiving data relating to a material movement activity and one or more material movement devices. The embodiment may also include identifying one or more characteristics of one or more materials associated with the material movement activity and of the one or more material movement devices. The embodiment may further include computing a surface profile of a transportation area. The embodiment may also include in response to determining at least one material movement device of the one or more material movement devices is unable to transport the one or more materials, adapting a transportation route of the at least one material movement device. The embodiment may further include deploying a plurality of swarm robots to generate a hybrid material movement path along the adapted transportation route.

### BACKGROUND

The present invention relates generally to the field of computing, and more particularly to a system for robotic collaboration for safe material movement in a workflow.

Materials may be moved from one location to another in any given area. For example, the materials may be moved in a construction area, a disaster area, and/or a factory floor. These materials may be transported by a material movement vehicle traveling along a surface. The surface may include a flat paved surface, such as concrete, or an off-road bumpy surface, such as rocks or mountainous terrain.

### SUMMARY

According to one embodiment, a method, computer system, and computer program product for robotic collaboration for safe material movement in a workflow is provided. The method, computer system, and computer program product may include receiving data relating to a material movement activity and one or more material movement devices to perform the material movement activity. The method, computer system, and computer program product may also include identifying one or more characteristics of one or more materials associated with the activity and one or more characteristics of the one or more material movement devices based on the data. The method, computer system, and computer program product may further include computing a surface profile of a transportation area of the one or more material movement devices. The method, computer system, and computer program product may also include in response to determining at least one material movement device of the one or more material movement devices is unable to transport the one or more materials based on the one or more characteristics of the one or more materials and the one or more characteristics of the one or more material movement devices, adapting a transportation route of the at least one material movement device based on the surface profile of the transportation area. The method, computer system, and computer program product may further include deploying a plurality of swarm robots to generate a hybrid material movement path along the adapted transportation route.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary computing environment according to at least one embodiment.

FIG. 2 illustrates an operational flowchart for robotic collaboration for safe material movement in a workflow in a robotic collaboration process according to at least one embodiment.

FIG. 3 is an exemplary diagram depicting a hybrid material movement path according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to a system for robotic collaboration for safe material movement in a workflow. The following described exemplary embodiments provide a system, method, and program product to, among other things, determine whether at least one material movement device is unable to transport the one or more materials based on characteristics of the one or more materials and the one or more material movement devices and, accordingly, deploy a plurality of swarm robots to generate a hybrid material movement path along an adapted transportation route. Therefore, the present embodiment has the capacity to improve industrial transportation technology by reducing the impact of vibrations on materials being transported.

As previously described, materials may be moved from one location to another in any given area. For example, the materials may be moved in a construction area, a disaster area, and/or a factory floor. These materials may be transported by a material movement vehicle traveling along a surface. The surface may include a flat paved surface, such as concrete, or an off-road bumpy surface, such as rocks or mountainous terrain. The material movement device may vibrate due to an uneven surface profile, which may damage the materials being transported. This problem is typically addressed by changing the route of the material movement device. However, merely changing the route of the material movement device is time consuming and wastes resources such as fuel or electricity. Changing the route may also fail to adequately protect the materials being transported.

It may therefore be imperative to have a system in place to reduce the impact of vibrations on materials being transported.

According to at least one embodiment, a computer-based method, computer system, and computer program product for robotic collaboration for safe material movement in a workflow is provided. The method comprises receiving data relating to a material movement activity and one or more material movement devices to perform the material movement activity, identifying one or more characteristics of one or more materials associated with the activity and one or more characteristics of the one or more material movement devices based on the data, computing a surface profile of a transportation area of the one or more material movement devices, determining whether at least one material movement device of the one or more material movement devices is unable to transport the one or more materials based on the one or more characteristics of the one or more materials and the one or more characteristics of the one or more material movement devices, in response to determining the at least one material movement device is unable to transport the one or more materials, adapting a transportation route of the at least one material movement device based on the surface profile of the transportation area, and deploying a plurality of swarm robots to generate a hybrid material movement path along the adapted transportation route. This embodiment has the advantage of reducing the impact of vibrations on materials being transported.

According to at least one embodiment, the method may further comprise monitoring a level of vibration of the one or more materials on the hybrid material movement path, and causing the plurality of swarm robots to alter the hybrid material movement path based on the monitored level of vibration. This embodiment has the advantage of validating and reconfiguring the hybrid material movement path for different types of materials and material movement devices.

According to at least one embodiment, the hybrid material movement path may be a combination of a natural surface of the adapted transportation route and a railway track. This embodiment has the advantage of reducing the impact of vibrations on materials transported by land.

According to at least one embodiment, the hybrid material movement path may be a combination of a natural surface of the adapted transportation route and a ropeway track. This embodiment has the advantage of enabling the materials to be transported by air to reduce the impact of vibrations on the materials.

According to at least one embodiment, the plurality of swarm robots deployed to generate the ropeway track may include a drone. This embodiment has the advantage of leveraging swarm robots to create an air-based portion of the hybrid material movement path.

According to at least one embodiment, determining whether the at least one material movement device is unable to transport the one or more materials may further comprise computing a level of vibration of the one or more materials transported by the at least one material movement device and determining the at least one material movement device is unable to transport the one or more materials based on determining the level of vibration of the one or more materials exceeds a threshold level of vibration for the one or more materials. This embodiment has the advantage of evaluating the tolerance of different types of materials to withstand vibration to optimize the transportation of the materials.

According to at least one embodiment, the one or more characteristics of the one or more material movement devices may include a suspension capability of the one or more material movement devices, and the threshold level of vibration may be computed based on the suspension capability of the one or more material movement devices. This embodiment has the advantage of safely transporting the materials without damage by considering the suspension capability of the material movement devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to determine whether at least one material movement device is unable to transport the one or more materials based on characteristics of the one or more materials and the one or more material movement devices and, accordingly, deploy a plurality of swarm robots to generate a hybrid material movement path along an adapted transportation route.

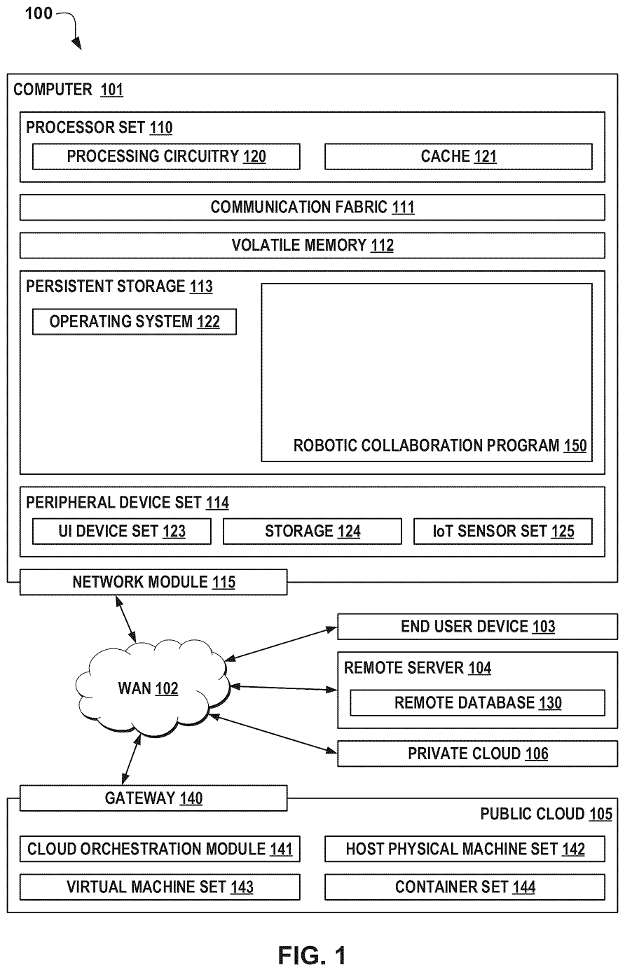

Referring to FIG. 1, an exemplary computing environment 100 is depicted, according to at least one embodiment. Computing environment 100 contains an example of an environment for the execution of at least some of the computer code involved in performing the inventive methods, such as a robotic collaboration program 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory 112 may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage 113 allows writing of data, deletion of data and re-writing of data. Some familiar forms of persistent storage 113 include magnetic disks and solid state storage devices. Operating system 122 may take several forms, such as various known proprietary operating systems or open source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices 114 and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. Peripheral device set 114 may also include a material movement device, an accelerometer, swarm robotic devices, and/or any other device for performing labor related tasks.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments the private cloud 106 may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

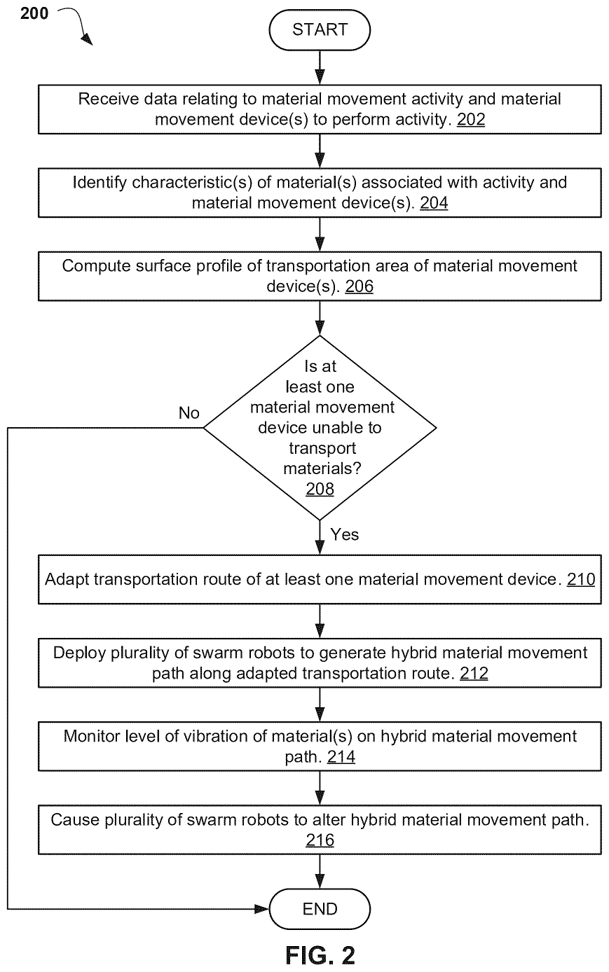

According to the present embodiment, the robotic collaboration program 150 may be a program capable of receiving data relating to a material movement activity and one or more material movement devices to perform the material movement activity, determining whether at least one material movement device is unable to transport the one or more materials based on characteristics of the one or more materials and the one or more material movement devices, and deploying a plurality of swarm robots to generate a hybrid material movement path along an adapted transportation route. Furthermore, notwithstanding depiction in computer 101, the robotic collaboration program 150 may be stored in and/or executed by, individually or in any combination, end user device 103, remote server 104, public cloud 105, and private cloud 106. The robotic collaboration method is explained in further detail below with respect to FIG. 2. It may be appreciated that the examples described below are not intended to be limiting, and that in embodiments of the present invention the parameters used in the examples may be different.

Referring now to FIG. 2, an operational flowchart for robotic collaboration for safe material movement in a workflow in a robotic collaboration process 200 is depicted according to at least one embodiment. At 202, the robotic collaboration program 150 receives the data relating to the material movement activity and the one or more material movement devices to perform the activity. As used herein, “material movement device” means a device that is used to transport objects from one location to another.

The data relating to the material movement activity may include the type of activity to be performed. Examples of an activity may include, but are not limited to, assembling objects in a manufacturing facility, removing objects in a disaster recovery area, and transporting objects from one location to another, (e.g., moving a shipping container from a ship to a dock). The data relating to the activity may also include the one or more materials associated with the activity. Examples of the material may include, but are not limited to, construction materials, chemicals, debris from a building, an automobile, and/or any object capable of being moved from a source to a destination, i.e., from one location to another.

The data relating to the one or more material movement devices to perform the activity may include the types of machines to perform the activity. Examples of a material movement device may include, but are not limited to, a crane, an automated device, an excavator, a trolley, cable cars, and/or any other device known in the art capable of moving objects from a source to a destination, i.e., from one location to another.

Then, at 204, the robotic collaboration program 150 identifies the one or more characteristics of the one or more materials associated with the material movement activity and the one or more characteristics of the one or more material movement devices. The one or more characteristics of the one or more materials and the one or more characteristics of the one or more material movement devices are identified based on the data.

The one or more characteristics of the one or more materials may include the dimensions, weight, fragility, and/or type of materials (e.g., rubber, concrete, plastic, or liquid) of the one or more materials. According to at least one embodiment, the robotic collaboration program 150 may identify the one or more characteristics based on the types of materials associated with the activity. For example, when the data received with respect to step 202 above indicates that the material is construction material, the robotic collaboration program 150 may access a database, such as remote database 130, to obtain the weight, dimensions, and fragility of the construction material. According to at least one other embodiment, the robotic collaboration program 150 may obtain the one or more characteristics from a camera. For example, a camera may be used to identify the material as chemicals and may detect the weight, dimensions, and fragility of the chemicals based on the type of chemical.

The one or more characteristics of the one or more material movement devices may include the suspension capability, dimensions, and/or weight of the one or more material movement devices. For example, the suspension capability of the one or more material movement devices may include the shock absorption ability of the material movement device on an uneven surface, such as a bumpy surface.

Next, at 206, the robotic collaboration program 150 computes the surface profile of the transportation area of the one or more material movement devices. As used herein, “transportation area” means a geographical area where the material movement activity is taking place. The transportation area may include all possible routes the one or more material movement devices could traverse, including both on and off-road routes. The surface profile of the transportation area may include the types of surfaces in the transportation area. For example, the types of surfaces may include, but are not limited to, paved surfaces, gravel surfaces, cratered surfaces, and/or dirt (e.g., dry or muddy) surfaces. The surface profile may also include the dimensions of the transportation area. For example, the dimensions of the transportation area may be 20×10 miles.

Then, at 208, the robotic collaboration program 150 determines whether the at least one material movement device of the one or more material movement devices is unable to transport the one or more materials. The determination is made based on the one or more characteristics of the one or more materials and the one or more characteristics of the one or more material movement devices.

According to at least one embodiment, determining whether the at least one material movement device of the one or more material movement devices is unable to transport the one or more materials includes computing a level of vibration of the one or more materials transported by the at least one material movement device. The level of vibration may include the back and forth displacement of the one or more materials as they are being transported. The level of vibration may be computed in real-time via an accelerometer attached to the one or more materials and/or based on the data relating to the surface profile, the one or more characteristics of the one or more materials, and the one or more characteristics of the one or more material movement devices, which may be collected historically.

The level of vibration may be low, moderate, or high. For example, where the surface profile is dirt, the material is a fragile chemical that weighs 20 pounds, and the material movement device does not have shock absorption capability and weighs 1,000 pounds, the level of vibration may be high, since a fragile chemical of a lower weight may have a higher probability of getting damaged. Where the surface profile is a paved surface, the material is a less fragile chemical that weighs 30 pounds, and the material movement device does have shock absorption capability and weighs 2,000 pounds, the level of vibration may be low, since a less fragile chemical of a higher weight may have a lower probability of getting damaged. Where the surface profile is gravel, the material is plastic that weighs 20 pounds, and the material movement device does not have shock absorption capability and weighs 1,000 pounds, the level of vibration may be moderate, since the plastic is not as fragile as the chemical. Where the surface profile is gravel, the material is rubber that weighs 20 pounds, and the material movement device does have shock absorption capability and weighs 2,000 pounds, the level of vibration may be low, since the rubber is not fragile.

According to at least one other embodiment, the determination that the at least one material movement device is unable to transport the one or more materials may be made based on determining the level of vibration of the one or more materials exceeds the threshold level of vibration for the one or more materials. The threshold level of vibration may be computed based on the suspension capability of the one or more material movement devices. The suspension capability may be directly proportional to the threshold level of vibration (e.g., a higher suspension capability may result in a higher threshold level of vibration). When the level of vibration exceeds the threshold level of vibration, the robotic collaboration program 150 may determine the at least one material movement device is unable to transport the one or more materials.

For example, where the level of vibration for a fragile chemical on a dirt surface being transported by a material movement device that does not have shock absorption capability, the high level of vibration may exceed the low threshold level of vibration. Where the level of vibration for a less fragile chemical on a paved surface being transported by a material movement device that does have shock absorption capability, the low level of vibration may not exceed the high threshold level of vibration. Where the level of vibration for a plastic on a gravel surface being transported by a material movement device that does not have shock absorption capability, the moderate level of vibration may not exceed the moderate threshold level of vibration. Where the level of vibration for a rubber on a gravel surface being transported by a material movement device that does have shock absorption capability, the low level of vibration may not exceed the high threshold level of vibration.

In response to determining the at least one material movement device is unable to transport the one or more materials (step 208, “Yes” branch), the robotic collaboration process 200 proceeds to step 210 to adapt the transportation route of the at least one material movement device. In response to determining the one or more material movement devices are able to transport the one or more materials (step 208, “No” branch), the robotic collaboration process 200 ends.

Next, at 210, the robotic collaboration program 150 adapts the transportation route of the at least one material movement device. The transportation route is adapted based on the surface profile of the transportation area. As described above with respect to step 206, the transportation area may include all possible routes the one or more material movement devices could traverse, including both on and off-road routes. Since the at least one material movement device may be unable to transport the one or more materials along a current route, the robotic collaboration program 150 may select a particular route in the transportation area where the hybrid material movement path may be generated. This particular route may be selected based on cost and efficiency. For example, the particular route may be selected based on availability of materials to generate the hybrid material movement path, the fastest time to transport the one or more materials, and/or the cheapest route to traverse. The time to transport the one or more materials may include a combination of the time it takes to generate the hybrid material movement path and the time it takes to transport the one or more materials to a final destination.

According to at least one embodiment, the particular route may be selected based on the length of sections where the at least one material movement device is able to operate without the railway or ropeway tracks of the hybrid material movement path.

For example, Route A may be 50 miles long and include 20 miles of paved surface. The 20 miles of paved surface may cause no vibration on the one or more materials. The remaining 30 miles may require the railway or ropeway track. Route B may be 50 miles long and include 10 miles of paved surface. Only the 10 miles of paved surface may cause no vibration on the one or more materials. The remaining 40 miles may require the railway or ropeway track. In this example, the particular route selected to adapt the transportation route may be Route A, since Route A enables the at least one material movement device to transport the one or more materials using more of the natural surface than Route B.

Then, at 212, the robotic collaboration program 150 deploys the plurality of swarm robots to generate the hybrid material movement path along the adapted transportation route. The hybrid material movement path may mitigate and/or substantially eliminate the level of vibration of the one or more materials. The robotic collaboration program 150 may send a signal to the plurality of swarm robots to deploy the swarm robots to target locations of the adapted transportation route. The target locations may be locations along the adapted transportation route where the railway or ropeway tracks may be generated. The plurality of swarm robots may include, but are not limited to, autonomous mobile robots, automated guided vehicles, and/or drones.

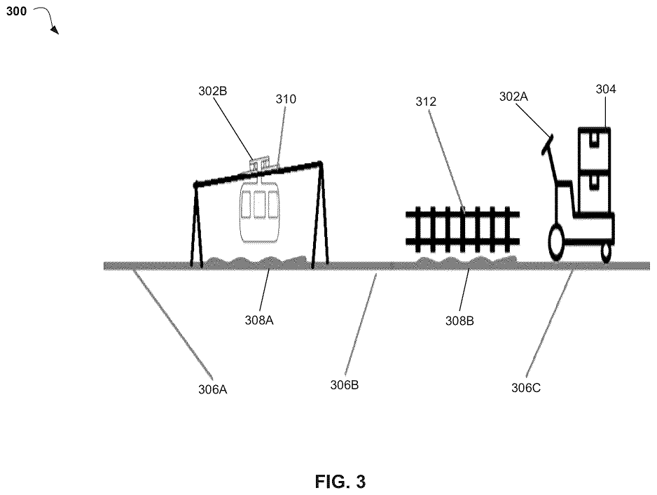

According to at least one embodiment, the hybrid material movement path may be a combination of a natural surface of the adapted transportation route and a railway track, as illustrated in FIG. 3. The railway track may be generated over any uneven surfaces along the adapted transportation route. For example, where the adapted transportation route is Route A, Route A may include a bumpy dirt surface on one or more portions. Continuing the example, the railway track may be generated over the bumpy dirt surface to prevent vibration of the one or more materials.

According to at least one other embodiment, the hybrid material movement path may be a combination of a natural surface of the adapted transportation route and a ropeway track, as illustrated in FIG. 3. The plurality of swarm robots deployed to generate the ropeway track may include the drone. The done may generate the rope or cable portions of the artificial structure, whereas the ground based robots may generated the supports for the ropes or cables. The ropeway track may be generated over any uneven surfaces along the adapted transportation route and/or over any cratered surfaces along the adapted transportation route. For example, where the adapted transportation route is Route A, Route A may include a bumpy dirt surface on one portion and a cratered surface on another portion. Continuing the example, the ropeway track may be generated over the bumpy dirt surface and over the cratered surface to prevent vibration of the one or more materials. In another example, the railway track may be generated over the bumpy dirt surface and the ropeway track may be generated over the cratered surface.

According to at least one further embodiment, the hybrid material movement path may be generated by the plurality of swarm robots removing any uneven surfaces along the adapted transportation route. The plurality of swarm robots may use a combination of digging, grinding, and/or bulldozing and filling the space created by the removal of the uneven portions of the natural surface with concrete or asphalt. For example, the excavator may remove the bumps along the dirt surface and fill in the dirt surface with the concrete or asphalt.

According to at least one other embodiment, a random forest algorithm may be used to determine whether to generate the railway track, the ropeway track, or a combination of both. The data received above in step 202 may be preprocessed via data cleaning, data normalization, and/or feature selection. The relevant features in the data may then be extracted, which may include the surface profile data, characteristics of the materials, and characteristics of the material movement devices. The relevant features may train the random forest algorithm. Once the random forest algorithm is trained, the algorithm may be evaluated to ensure the algorithm is accurately predicting the proper hybrid material movement path. The validation process may include metrics such as accuracy, precision, recall, and/or F1 Score. In some embodiments, parameters of the random forest algorithm may be adjusted to improve the algorithm's performance. These parameters may include, but are not limited to, the number of trees, maximum depth of trees, and/or minimum number of samples required to split a node. For example, the trained random forest algorithm may predict whether the hybrid material movement path is a railway track, a ropeway track, or a combination of both.

Next, at 214, the robotic collaboration program 150 monitors the level of vibration of the one or more materials on the hybrid material movement path. As the at least one material movement devices traverses the railway track or the ropeway track, the accelerometer may measure the level of vibration of the one or more materials in real-time. For example, as the at least one material movement device traverses the railway track, the level of vibration may still exceed the threshold level of vibration. In another example, as the at least one material movement device traverses the ropeway track, the level of vibration may not exceed the threshold level of vibration. Thus, in embodiments of the present invention, the level of vibration may be monitored continuously such that changes may be made to the railway track or ropeway track for the transportation of future materials, described in further detail below with respect to step 216.

Then, at 216, the robotic collaboration program 150 causes the plurality of swarm robots to alter the hybrid material movement path. The alteration to the hybrid material movement path is made based on the monitored level of vibration. When the level of vibration of the one or more materials continue to exceed the threshold level of vibration even as the at least one material movement devices traverses the ropeway or railway track portion of the adapted transportation route, the determination may be made that the hybrid material movement path needs to be modified. For example, as the at least one material movement device traverses the railway track, and the level of vibration still exceeds the threshold level of vibration, a signal may be sent to the plurality of swarm robots alter the hybrid material movement path.

According to at least one embodiment, the plurality of swarm robots may alter the hybrid material movement path by disassembling the railway track and/or the ropeway track and reconstructing the railway track and/or the ropeway track with the recycled parts. According to at least one other embodiment, the plurality of swarm robots may alter the hybrid material movement path by supplementing the railway track and/or ropeway track with 3D printed elements. For example, where the rails of the railway track have uneven surfaces, a 3D printed metal may be printed on the rails to smoothen the surface.

Referring now to FIG. 3, an exemplary diagram 300 depicting a hybrid material movement path 306A-C, 310, 312 is shown according to at least one embodiment. In the diagram 300, the material movement devices 302A, 302B may include a trolley 302A and a cable car 302B. The trolley 302A and the cable car 302B may be transporting the one or more materials 304 to a final destination. The surface profile data may indicate that the adapted transportation route includes a first uneven surface 308A and a second uneven surface 308B. In this embodiment, the first uneven surface 308A and the second uneven surface 308B may be bumps 308A, 308B along the adapted transportation route. When the level of vibration on the one or more materials 304 exceeds the threshold level of vibration, the hybrid material movement path 306A-C, 310, 312 may be generated. The hybrid material movement path 306A-C, 310, 312 may include the ropeway track 310, the railway track 312, as well as a plurality of natural surfaces 306A, 306B, 306C. To mitigate the impact of vibration, the trolley 302A may traverse the railway track 312 and the cable car 302B may traverse the ropeway track 310 such that the first uneven surface 308A and the second uneven surface 308B do not cause damage to the one or more materials 304.

It may be appreciated that FIGS. 2 and 3 provide only an illustration of one implementation and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of robotic collaboration for safe material movement in a workflow, the method comprising:
receiving data relating to a material movement activity and one or more material movement devices to perform the activity;
identifying one or more characteristics of one or more materials associated with the material movement activity and one or more characteristics of the one or more material movement devices based on the data;
computing a surface profile of a transportation area of the one or more material movement devices;
determining whether at least one material movement device of the one or more material movement devices is unable to transport the one or more materials based on the one or more characteristics of the one or more materials and the one or more characteristics of the one or more material movement devices;
in response to determining the at least one material movement device is unable to transport the one or more materials, adapting a transportation route of the at least one material movement device based on the surface profile of the transportation area; and
deploying a plurality of swarm robots to generate a hybrid material movement path along the adapted transportation route.

2. The computer-based method of claim 1, further comprising:
monitoring a level of vibration of the one or more materials on the hybrid material movement path; and
causing the plurality of swarm robots to alter the hybrid material movement path based on the monitored level of vibration.

3. The computer-based method of claim 1, wherein the hybrid material movement path is a combination of a natural surface of the adapted transportation route and a railway track.

4. The computer-based method of claim 1, wherein the hybrid material movement path is a combination of a natural surface of the adapted transportation route and a ropeway track.

5. The computer-based method of claim 4, wherein the plurality of swarm robots deployed to generate the ropeway track includes a drone.

6. The computer-based method of claim 1, wherein determining whether the at least one material movement device is unable to transport the one or more materials further comprises:
computing a level of vibration of the one or more materials transported by the at least one material movement device; and
determining the at least one material movement device is unable to transport the one or more materials based on determining the level of vibration of the one or more materials exceeds a threshold level of vibration for the one or more materials.

7. The computer-based method of claim 6, wherein:
the one or more characteristics of the one or more material movement devices include a suspension capability of the one or more material movement devices; and
the threshold level of vibration is computed based on the suspension capability of the one or more material movement devices.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving data relating to a material movement activity and one or more material movement devices to perform the activity;
identifying one or more characteristics of one or more materials associated with the activity and one or more characteristics of the one or more material movement devices based on the data;
computing a surface profile of a transportation area of the one or more material movement devices;
determining whether at least one material movement device of the one or more material movement devices is unable to transport the one or more materials based on the one or more characteristics of the one or more materials and the one or more characteristics of the one or more material movement devices;
in response to determining the at least one material movement device is unable to transport the one or more materials, adapting a transportation route of the at least one material movement device based on the surface profile of the transportation area; and
deploying a plurality of swarm robots to generate a hybrid material movement path along the adapted transportation route.

9. The computer system of claim 8, the method further comprising:
monitoring a level of vibration of the one or more materials on the hybrid material movement path; and
causing the plurality of swarm robots to alter the hybrid material movement path based on the monitored level of vibration.

10. The computer system of claim 8, wherein the hybrid material movement path is a combination of a natural surface of the adapted transportation route and a railway track.

11. The computer system of claim 8, wherein the hybrid material movement path is a combination of a natural surface of the adapted transportation route and a ropeway track.

12. The computer system of claim 11, wherein the plurality of swarm robots deployed to generate the ropeway track includes a drone.

13. The computer system of claim 8, wherein determining whether the at least one material movement device is unable to transport the one or more materials further comprises:
computing a level of vibration of the one or more materials transported by the at least one material movement device; and
determining the at least one material movement device is unable to transport the one or more materials based on determining the level of vibration of the one or more materials exceeds a threshold level of vibration for the one or more materials.

14. The computer system of claim 13, wherein:
the one or more characteristics of the one or more material movement devices include a suspension capability of the one or more material movement devices; and
the threshold level of vibration is computed based on the suspension capability of the one or more material movement devices.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving data relating to a material movement activity and one or more material movement devices to perform the activity;
identifying one or more characteristics of one or more materials associated with the activity and one or more characteristics of the one or more material movement devices based on the data;
computing a surface profile of a transportation area of the one or more material movement devices;
determining whether at least one material movement device of the one or more material movement devices is unable to transport the one or more materials based on the one or more characteristics of the one or more materials and the one or more characteristics of the one or more material movement devices;
in response to determining the at least one material movement device is unable to transport the one or more materials, adapting a transportation route of the at least one material movement device based on the surface profile of the transportation area; and
deploying a plurality of swarm robots to generate a hybrid material movement path along the adapted transportation route.

16. The computer program product of claim 15, the method further comprising:
monitoring a level of vibration of the one or more materials on the hybrid material movement path; and
causing the plurality of swarm robots to alter the hybrid material movement path based on the monitored level of vibration.

17. The computer program product of claim 15, wherein the hybrid material movement path is a combination of a natural surface of the adapted transportation route and a railway track.

18. The computer program product of claim 15, wherein the hybrid material movement path is a combination of a natural surface of the adapted transportation route and a ropeway track.

19. The computer program product of claim 18, wherein the plurality of swarm robots deployed to generate the ropeway track includes a drone.

20. The computer program product of claim 15, wherein determining whether the at least one material movement device is unable to transport the one or more materials further comprises:
computing a level of vibration of the one or more materials transported by the at least one material movement device; and
determining the at least one material movement device is unable to transport the one or more materials based on determining the level of vibration of the one or more materials exceeds a threshold level of vibration for the one or more materials.
